(19) United States
(12) Patent Application Publication
(10) Pub. No.: US 2026/0168833 A1
(43) Pub. Date: Jun. 18, 2026

(54) THERMAL FLOW METER

(71) Applicant: Surpass Industry Co., Ltd., Saitama (JP)

(72) Inventors: Hiroshi Imai, Saitama (JP); Hiroki Igarashi, Saitama (JP)

(21) Appl. No.: 19/419,866

(22) Filed: Dec. 15, 2025

(30) Foreign Application Priority Data
Dec. 17, 2024 (JP) 2024-220976

(51) Int. Cl. G01F 1/69

(52) U.S. Cl. CPC G01F 1/69

(57) ABSTRACT

Provided is a thermal flow meter including: a measurement tube having an inflow port into which a liquid flows and an outflow port out of which the liquid flowing in from the inflow port is allowed to flow and having an internal flow channel formed extending along an axis; and a temperature detecting substrate in which a heating resistance element and a temperature detecting resistance element are formed on a detection surface along the axis and the detection surface is joined to the measurement tube along the axis, and the measurement tube is formed of a thermal conductive fluororesin material containing a fluororesin material and a thermal conductive material that is dispersed in the fluororesin material and has higher thermal conductivity than the fluororesin material.

### CROSS-REFERENCE TO RELATED APPLICATIONS

This application claims foreign priority benefits under U.S.C. § 119 to Japanese Patent Application No. 2024-220976 filed on Dec. 17, 2024, the contents of which is hereby incorporated by reference in its entirety.

### BACKGROUND

### 1. Technical Field

The present disclosure relates to a thermal flow meter.

### 2. Description of Related Art

Thermal flow meters are known in which a heating resistance element and a temperature detecting resistance element are adhered in a liquid flow direction to a measurement tube and the flow rate of a liquid flowing through the measurement tube is measured based on a timing of heating applied to a liquid by the heating resistance element and a timing of temperature detection performed on the liquid by the temperature detecting resistance element (see, for example, Japanese Patent No. 6539458).

In the thermal flow meter disclosed in Japanese U.S. Pat. No. 6,539,458, the detection surface of a glass temperature detecting substrate on which the heating resistance element and the temperature detecting resistance element are formed is joined to a flat surface of the measurement tube formed of glass.

Such a thermal flow meter instantaneously heats the heating resistance element to heat a liquid via the measurement tube and detects heat transferred to the temperature detecting resistance element via the measurement tube as a voltage signal when the heated liquid passes through a portion of the measurement tube to which the temperature detecting resistance element is joined.

Since silicon dioxide, which is the main component of glass, and an alkaline liquid are subjected to a neutralization reaction therebetween, the measurement tube formed of glass suffers from a disadvantage of low corrosion resistance against the alkaline liquid. Thus, to measure the flow rate of an alkaline liquid, it is preferable to use a tubular flow channel formed of a resin material having high corrosion resistance against alkaline liquids.

However, since resin materials have lower thermal conductivity than glass, if the thickness of a flow channel formed of a resin material is substantially the same as the thickness of a flow channel formed of glass, it is not possible to suitably heat a liquid via the measurement tube. In such a case, it may be not possible to suitably determine the temperature of a liquid by using a temperature detecting resistance element.

### SUMMARY

The present disclosure has been made in view of such circumstances and intends to provide a thermal flow meter that can suitably measure a flow rate of a liquid by using a temperature detecting substrate on which a temperature detecting resistance element is formed on a detection surface while enhancing corrosion resistance against alkaline or acidic liquids.

To solve the problem described above, the present disclosure employs the following solutions.

A thermal flow meter according to one aspect of the present disclosure includes: a measurement tube having an inflow port and an outflow port and having an internal flow channel formed extending along an axis, wherein a liquid flows into the inflow port and the liquid flowing in from the inflow port is allowed to flow out of the outflow port; and a temperature detecting substrate having a heating resistance element and a temperature detecting resistance element formed on a detection surface along the axis, the detection surface being joined to the measurement tube along the axis, and the measurement tube is formed of a thermal conductive fluororesin material containing a fluororesin material and a thermal conductive material, the thermal conductive material being dispersed in the fluororesin material and having higher thermal conductivity than the fluororesin material.

According to the thermal flow meter according to one aspect of the present disclosure, since the measurement tube in which the internal flow channel is formed that allows a liquid to flow therethrough is formed of a thermal conductive fluororesin material containing a fluororesin material, the corrosion resistance against alkaline or acidic liquids can be enhanced. Further, since the thermal conductive material having higher thermal conductivity than the fluororesin material is dispersed in the thermal conductive fluororesin material forming the measurement tube, the thermal conductivity of the measurement tube, which contains the fluororesin material having lower thermal conductivity than glass, can be increased. It is thus possible to ensure better thermal conductivity between the measurement tube and a liquid and suitably measure the flow rate of the liquid by using the temperature detecting substrate where the temperature detecting resistance element is formed on the detection surface while enhancing the corrosion resistance against alkaline or acidic liquids.

In the thermal flow meter according to one aspect of the present disclosure, a preferable configuration is such that the thermal conductive material consists of carbon nanotubes, and the thermal conductive fluororesin material contains the carbon nanotubes at a ratio of 0.020% by weight or greater and 0.060% by weight or less.

According to the thermal flow meter of the present configuration, because the carbon nanotubes of 0.020% by weight or greater are dispersed in the fluororesin material, the thermal conductivity of the measurement tube can be increased. This is because the use of tubular carbon nanotubes having a predetermined length as the thermal conductive material can add thermal conductivity even with a smaller quantity thereof than in the user of other granular thermal conductive materials such as carbon black or iron powder. Further, since the ratio of the carbon nanotubes contained in the thermal conductive fluororesin material is a minute ratio of 0.060% by weight or less, contamination of a liquid due to contact between the measurement tube and the liquid can be suppressed unlike the case of other granular thermal conductive materials such as carbon black or iron powder.

In the thermal flow meter according to one aspect of the present disclosure, a preferable configuration is such that the detection surface is a surface formed flat, and a flat surface is formed on an outer circumferential surface of the measurement tube, the detection surface of the temperature detecting substrate facing and being arranged on the flat surface.

According to the thermal flow meter of the present configuration, because the flat surface formed on the outer circumferential surface of the measurement tube and the detection surface formed flat are joined to each other, a wide contact area can be ensured to enhance joinability therebetween.

In the thermal flow meter according to one aspect of the present disclosure, a preferable configuration is such that the thermal flow meter includes a metal sheet arranged between the flat surface of the measurement tube and the detection surface of the temperature detecting substrate so as to cover the flat surface, a first face of the sheet is joined to the flat surface of the measurement tube, and a second face of the sheet is joined to the detection surface of the temperature detecting substrate.

According to the thermal flow meter of the present configuration, since a metal sheet is arranged between the flat surface of the measurement tube and the detection surface of the temperature detecting substrate so as to cover the flat surface, even when a part of a corrosive gas volatilized from a liquid flowing inside the measurement tube permeates the measurement tube, it is possible to suitably prevent the corrosive gas from corroding the heating resistance element and the temperature detecting resistance element.

In the thermal flow meter of the above configuration, a preferable configuration is such that the first face of the sheet and the flat surface of the measurement tube are joined to each other via a heat welding film that provides the joining when heated, and the second face of the sheet and the detection surface of the temperature detecting substrate are joined to each other via an adhesive agent.

According to the thermal flow meter of the present configuration, by using the heat welding film to perform joining between the first face of the sheet, which is susceptible to a corrosive gas permeating the measurement tube, and the flat surface of the measurement tube, it is possible to suitably perform the joining while preventing the impact of a corrosive gas. Further, it is possible to suitably join the second face of the sheet and the detection surface of the temperature detecting substrate by using the adhesive agent.

In the thermal flow meter of the above configuration, a preferable configuration is such that the sheet is formed of a nickel alloy containing nickel as a main component.

According to the thermal flow meter of the present configuration, the use of the sheet formed of a nickel alloy containing nickel as the main component can reliably prevent a corrosive gas from corroding the heating resistance element and the temperature detecting resistance element.

In the thermal flow meter according to one aspect of the present disclosure, a preferable configuration is such that a first distance from the detection surface of the temperature detecting substrate to an inner circumferential surface of the internal flow channel is shorter than a second distance from the top of the measurement tube to the inner circumferential surface of the internal flow channel.

According to the thermal flow meter of the present configuration, since the first distance is shorter than the second distance, the heating property on a liquid inside the internal flow channel applied by the heating resistance element and the temperature detection property on a liquid applied by the temperature detecting resistance element can be enhanced compared to a case where the first and second distances are the same.

In the thermal flow meter according to one aspect of the present disclosure, a preferable configuration is such that the temperature detecting substrate is made of glass.

According to the thermal flow meter of the present configuration, since the glass temperature detecting substrate less likely to be deformed by heating is used, bending that may occur during adhesion of the temperature detecting substrate to the measurement tube or during the use thereof can be suppressed.

According to the present disclosure, it is possible to provide a thermal flow meter that can suitably measure a flow rate of a liquid by using a temperature detecting substrate having a temperature detecting resistance element formed on a detection surface while enhancing corrosion resistance against alkaline or acidic liquids.

### BRIEF DESCRIPTION OF THE DRAWINGS

FIG. 1 is a longitudinal sectional view of a thermal flow meter according to a first embodiment of the present disclosure.

FIG. 2 is a longitudinal sectional view of a sensor unit illustrated in FIG. 1.

FIG. 3A is a plan view of a measurement tube and a sensor substrate illustrated in FIG. 2.

FIG. 3B is a longitudinal sectional view of the measurement tube and the sensor substrate illustrated in FIG. 2.

FIG. 3C is a bottom view of the measurement tube and the sensor substrate illustrated in FIG. 2.

FIG. 4 is an arrow A-A end face view of the sensor unit illustrated in FIG. 2.

FIG. 5 is an arrow B-B end face view of the measurement tube and the sensor substrate illustrated in FIG. 3B.

FIG. 6 is a plan view of the sensor substrate illustrated in FIG. 3B when viewed from the detection surface side.

FIG. 7 is a partial enlarged view of a part C of the measurement tube and the sensor substrate illustrated in FIG. 4.

FIG. 8 is a graph illustrating a relationship between the amount of addition of carbon nanotubes and the volume resistivity of a mixed fluororesin material.

FIG. 9 is a graph illustrating a relationship between the water flow duration and the number of particles.

### DETAILED DESCRIPTION

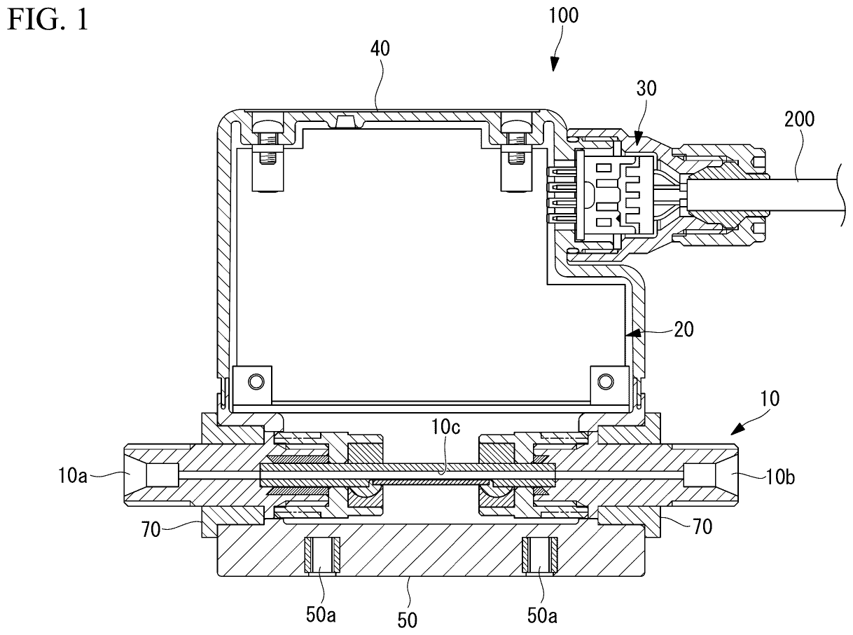

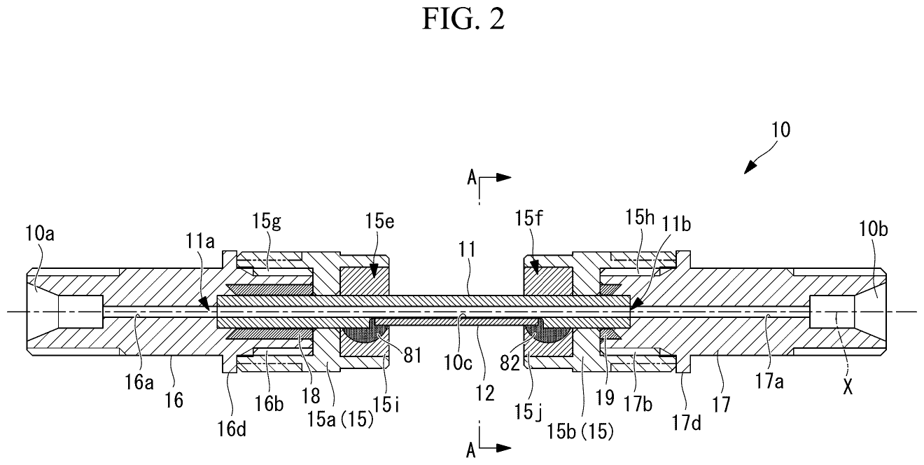

A thermal flow meter 100 according to one embodiment of the present disclosure will be described below with reference to the drawings. FIG. 1 is a longitudinal sectional view of the thermal flow meter 100 according to the first embodiment of the present disclosure. FIG. 2 is a longitudinal sectional view of a sensor unit 10 illustrated in FIG. 1.

The thermal flow meter 100 of the present embodiment is a thermal flow meter configured to heat a liquid flowing through an internal flow channel and determine the temperature of the heated liquid to measure the flow rate of the liquid. The thermal flow meter 100 of the present embodiment is suitable for measuring a minute flow rate of, for example, 0.1 cc/min to 30 cc/min. The liquid to be measured for the flow rate by the thermal flow meter 100 of the present embodiment includes a corrosive liquid such as an alkaline liquid or an acidic liquid. The corrosive liquid is a chemical solution used for a semiconductor manufacturing device, such as, for example, ammonia water, hydrofluoric acid, or hydrochloric acid.

As shown in FIGS. 1 and 2, the thermal flow meter 100 of the embodiment includes a sensor unit 10, a control substrate 20, a relay substrate 30, an upper case 40, and a bottom case 50.

The sensor unit 10 lets incoming liquid from an inlet 10a connected to external piping (not shown) flow out through an outlet 10b connected to external piping (not shown), and at the same time, measures a flow rate of the liquid flowing through an internal flow passage 10c. The sensor unit 10 does not directly calculate the flow rate of the liquid, but detects the temperature of the liquid heated by a heating resistance wire 12a (a heating resistance element) that will be described later with temperature detecting resistance wires 12b, 12c, 12d, and 12e (temperature detecting resistance elements), and transmits a temperature detection signal indicating the detected temperature to the control substrate 20 through a signal wire (not shown). The sensor unit 10 will be described later in detail.

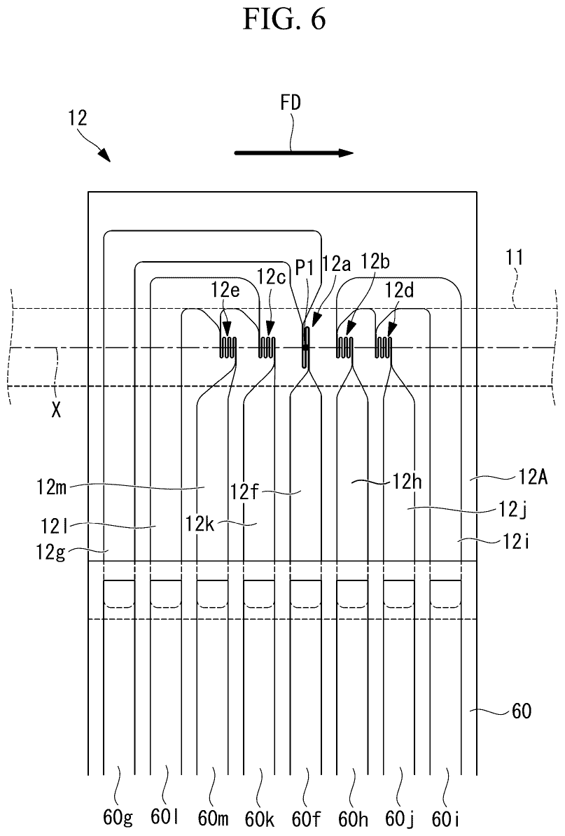

The control substrate 20 is a device that transmits a voltage signal to the heating resistance wire 12a of the sensor unit 10 to heat the heating resistance wire 12a, and also calculates a flow rate of the liquid based on temperatures transmitted from the temperature detecting resistance wires 12b, 12c, 12d, 12e. The control substrate 20 outputs the voltage signal to heat the heating resistance wire 12a, via a flexible substrate 60 (see FIG. 6) to a sensor substrate 12. Furthermore, the control substrate 20 outputs, via the flexible substrate 60 to the sensor substrate 12, a voltage signal to detect resistance values of the temperature detecting resistance wires 12b, 12c, 12d, 12e.

The control substrate 20 outputs the voltage signal to the heating resistance wire 12a to periodically repeat a heating period to heat the heating resistance wire 12a and a non-heating period not to heat the heating resistance wire 12a. The heating period is set to be shorter than the non-heating period. That is, the heating period is set to a rate of less than 0.5 of a cycle obtained by totaling the heating period and the non-heating period. A rate to a cycle of the heating period may be set to be less than 0.4.

The relay substrate 30 that relays various signals transmitted and received between the control substrate 20 and an external device (not shown). A cable 200 for transmitting and receiving the various signals to and from the external device (not shown) is connected to the relay substrate 30.

The upper case 40 serves as a housing for an upper portion of the thermal flow meter 100, and accommodates the control substrate 20 inside.

The bottom case 50 serves as a housing for a lower portion of the thermal flow meter 100, and accommodate the sensor unit 10 inside. With the sensor unit 10 inserted in the bottom case 50, a stopper 70 is inserted between the bottom case 50 and the sensor unit 10 from the inlet 10a side of the sensor unit 10.

With the sensor unit 10 inserted in the bottom case 50, a stopper 70 is inserted between the bottom case 50 and the sensor unit 10 from the outlet 10b side of the sensor unit 10. The sensor unit 10 becomes fixed to the bottom case 50 by means of the stopper 70. The bottom case 50 has fastening holes 50a on its bottom surface and is fixed to an installation surface (not shown) by fastening bolts (not shown) that are inserted from below the installation surface.

Next, the sensor unit 10 will be described in detail. As shown in FIG. 2, the sensor unit 10 has a measurement tube 11, a sensor substrate (temperature detecting substrate) 12, a nut 15, an inlet-side body 16, an outlet-side body 17, an inlet-side ferrule 18, and an outlet-side ferrule 19.

The measurement tube 11 is a tube having an inflow port 11a into which a liquid flows and an outflow port 11b out of which the liquid flowing in from the inflow port 11a is allowed to flow. The internal flow channel 10c that is circular in sectional view and extends along the axis X is formed in the measurement tube 11. The measurement tube 11 is formed of a mixed fluororesin material having corrosion resistance against alkaline or acidic liquids. The mixed fluororesin material will be described later.

The inflow-side body 16 is a member having the inflow port 11a of the measurement tube 11 inserted therein and having a connection flow channel 16a (a first connection flow channel) formed inside thereof that is circular in sectional view. An external thread 16b is formed on the outer circumferential surface of the end on the outflow port 10b side of the inflow-side body 16.

The outflow-side body 17 is a member having the outflow port 11b of the measurement tube 11 inserted therein and having a connection flow channel 17a (a second connection flow channel) formed inside thereof that is circular in sectional view. An external thread 17b is formed on the outer circumferential surface of the end on the inflow port 10a side of the outflow-side body 17. The inflow-side body 16 and the outflow-side body 17 are formed of a resin material having high corrosion resistance (for example, polytetrafluoroethylene (PTFE)).

The nut 15 consists of an inflow-side nut 15a attached to the inflow-side body 16 and an outflow-side nut 15b attached to the outflow-side body 17. The inflow-side nut 15a is a circular cylindrical member inserted on the outflow port 11b side from the inflow-side body 16 along the outer circumferential surface of the measurement tube 11. An internal thread 15g is formed in the inner circumferential surface of the end on the inflow port 10a side of the inflow-side nut 15a. Further, the outflow-side nut 15b is a circular cylindrical member inserted on the inflow port 11a side from the outflow-side body 17 along the outer circumferential surface of the measurement tube 11. An internal thread 15h is formed in the inner circumferential surface of the end on the outflow port 10b side of the outflow-side nut 15b.

The internal thread 15g of the inflow-side nut 15a and the external thread 16b of the inflow-side body 16 are fastened to each other, and thereby the inflow-side nut 15a is attached to the inflow-side body 16. Similarly, the internal thread 15h of the outflow-side nut 15b and the external thread 17b of the outflow-side body 17 are fastened to each other, and thereby the outflow-side nut 15b is attached to the outflow-side body 17.

A recess 15e (a first recess) recessed toward the inflow port 10a is formed at the end on the outflow port 10b side of the inflow-side nut 15a. The end on the inflow port 11a side of the sensor substrate 12 including an adhesive agent 81 is inserted in the recess 15e. The recess 15e is filled with a filling material 15i. The end on the inflow port 11a side of the sensor substrate 12 is fixed to the inflow-side nut 15a by the filling material 15i.

A recess 15f (a second recess) recessed toward the outflow port 10b is formed at the end on the inflow port 10a side of the outflow-side nut 15b. The end on the outflow port 11b side of the sensor substrate 12 including an adhesive agent 82 is inserted in the recess 15f. Further, the recess 15f is filled with a filling material 15j. The end on the outflow port 11b side of the sensor substrate 12 is fixed to the outflow-side nut 15b by the filling material 15j.

The inflow-side ferrule 18 is a member made of a resin (for example, PTFE) formed in a circular cylindrical shape inserted between the outer circumferential surface of the measurement tube 11 and the inner circumferential surface of the end on the outflow port 10b side of the inflow-side body 16. The outflow-side ferrule 19 is a member made of a resin (for example, PTFE) formed in a circular cylindrical shape inserted between the outer circumferential surface of the measurement tube 11 and the inner circumferential surface of the end on the inflow port 10a side of the outflow-side body 17.

The sensor unit 10 of the thermal flow meter 100 of the present embodiment is assembled by fastening the internal thread 15g of the inflow-side nut 15a onto the external thread 16b of the inflow-side body 16 with the inflow port 11a of the measurement tube 11 and the inflow-side ferrule 18 being inserted in the end on the outflow port 10b side of the inflow-side body 16 and by fastening the internal thread 15h of the outflow-side nut 15b onto the external thread 17b of the outflow-side body 17 with the outflow port 11b of the measurement tube 11 and the outflow-side ferrule 19 being inserted in the end on the inflow port 10a side of the outflow-side body 17.

When the tip on the inflow port 10a side of the inflow-side nut 15a comes into contact with a protruding part 16d of the inflow-side body 16, the fastening between the internal thread 15g of the inflow-side nut 15a and the external thread 16b of the inflow-side body 16 is completed. When the tip on the outflow port 10b side of the outflow-side nut 15b comes into contact with a protruding part 17d of the outflow-side body 17, the fastening between the internal thread 15h of the outflow-side nut 15b and the external thread 17b of the outflow-side body 17 is completed.

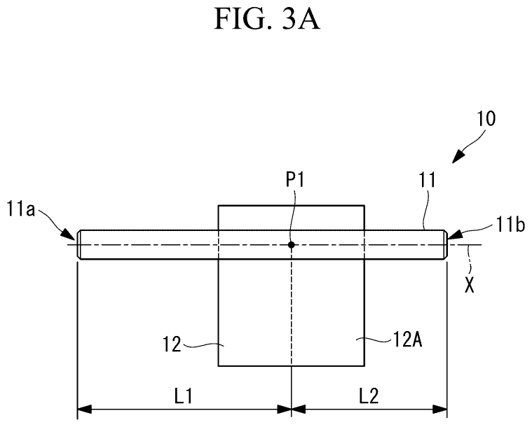

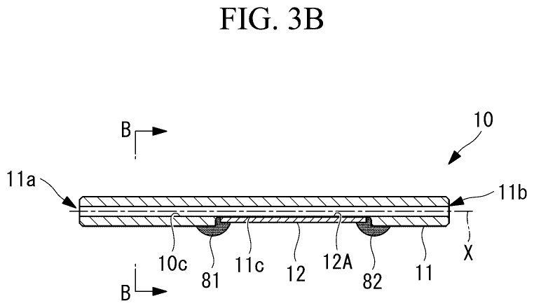

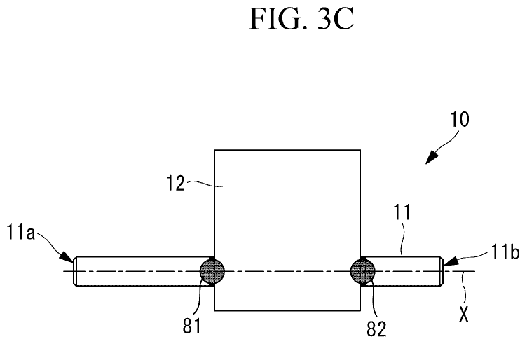

FIG. 3A is a plan view of the measurement tube 11 and the sensor substrate 12 illustrated in FIG. 2. FIG. 3B is a longitudinal sectional view of the measurement tube 11 and the sensor substrate 12 illustrated in FIG. 2. FIG. 3C is a bottom view of the measurement tube 11 and the sensor substrate 12 illustrated in FIG. 2.

As illustrated in FIG. 3B and FIG. 3C, the end on the inflow port 11a side of the sensor substrate 12 and the end on the inflow port 11a side of the flat surface 11c formed to the measurement tube 11 are joined via the adhesive agent 81, and the end on the outflow port 11b side of the sensor substrate 12 and the end on the outflow port 11b side of the flat surface 11c are joined via the adhesive agent 82. As the adhesive agent 81 and the adhesive agent 82, for example, an epoxy resin-based adhesive agent can be used.

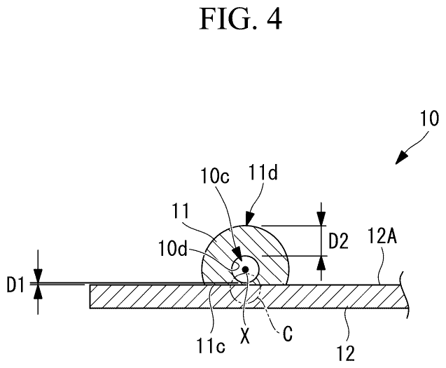

FIG. 4 is an arrow A-A end face view of the sensor unit 10 illustrated in FIG. 2. As illustrated in FIG. 4, in the measurement tube 11, the upper side in the cross section taken along a plane perpendicular to the axis X is substantially circular at a position to which the sensor substrate 12 is adhered. Out of the outer circumferential surface of the measurement tube 11, a surface on which the detection surface 12A of the sensor substrate 12 is arranged in contact is the flat surface 11c that is flat. The detection surface 12A and the flat surface 11c are joined to each other at respective positions along the axis X.

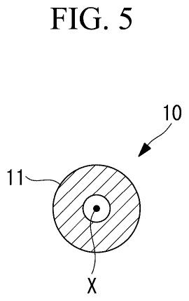

FIG. 5 is an arrow B-B end face view of the measurement tube 11 and the sensor substrate 12 illustrated in FIG. 3B. As illustrated in FIG. 5, in the measurement tube 11, the cross section taken along a plane perpendicular to the axis X is circular at a position to which the sensor substrate 12 is not adhered.

As illustrated in FIG. 4, the distance D1 (the first distance) from the detection surface 12A of the sensor substrate 12 to the inner circumferential surface 10d of the internal flow channel 10c is shorter than the distance D2 (the second distance) from the top 11d of the measurement tube 11 to the inner circumferential surface 10d of the internal flow channel 10c. This is for making the distance D1 from the detection surface 12A of the sensor substrate 12 to the inner circumferential surface 10d of the internal flow channel 10c shorter than the distance D2 to improve the thermal conductivity from the heating resistance wire 12a to the liquid and improve the temperature detection property provided by the temperature detecting resistance wire 12b and the temperature detecting resistance wire 12d. The distance D1 is preferably 0.2 mm or less, for example, 0.1 mm.

FIG. 6 is a plan view of the sensor substrate 12 shown in FIG. 3B seen from a detection surface 12A side. The sensor substrate 12 is a substrate made of glass (e.g., made of quartz glass having a high silicon dioxide content) with the temperature detecting resistance wire (the temperature detecting resistance element) 12e, the temperature detecting resistance wire (the temperature detecting resistance element) 12c, the heating resistance wire (the heating resistance element) 12a, the temperature detecting resistance wire (the temperature detecting resistance element) 12b and the temperature detecting resistance wire (the temperature detecting resistance element) 12d formed on the detection surface 12A along the axis X.

The detection surface 12A is a flatly formed surface extending along the axis X. The heating resistance wire 12a, the temperature detecting resistance wire 12b, and the temperature detecting resistance wire 12c are each formed of a metal film, such as of platinum, evaporated onto the glass substrate.

The liquid flowing through the measurement tube 11 flows along the axis X in a flow direction FD from the left toward the right in FIG. 6. Accordingly, when the heating resistance wire 12a is heated momentarily, the heated liquid flows along the axis X to a position of the temperature detecting resistance wire 12b and then to a position of the temperature detecting resistance wire 12d. The control substrate 20 detects electrical resistance values of the temperature detecting resistance wire 12b and the temperature detecting resistance wire 12d that change with temperature, to measure temperatures of the temperature detecting resistance wire 12b and the temperature detecting resistance wire 12d.

As shown in FIG. 6, a position P1 where the heating resistance wire 12a is disposed in the sensor substrate 12 is on the outlet 11b side of an intermediate position at an equal distance from both an inlet 11a side end portion of the sensor substrate 12 and an outlet 11b side end portion of the sensor substrate 12.

A distance L1 (see FIG. 3A) from the inlet 11a of the measurement tube 11 to the heating resistance wire 12a on the axis X is longer than a distance L2 (see FIG. 3A) from the outlet 11b of the measurement tube 11 to the heating resistance wire 12a on the axis X. Consequently, the distance from the inlet 11a of the measurement tube 11 to the heating resistance wire 12a can be increased, and turbulence or the like of the liquid flowing into the inlet 11a of the measurement tube 11 can be sufficiently reduced before the liquid is heated.

The control substrate 20 can calculate the flow speed of the liquid flowing in the measurement tube 11 from the timing at which the heating resistance wire 12a was momentarily heated and the timings at which the temperature detecting resistance wire 12b and the temperature detecting resistance wire 12d subsequently detect the temperature of the heated liquid. Also, the control substrate 20 can calculate the flow rate of the liquid from the obtained flow speed and the cross-sectional area of the measurement tube 11.

When the heating resistance wire 12a is momentarily heated, heat transferred from the heating resistance wire 12a to the detection surface 12A is transferred along the axis X in a direction reverse to the flow direction FD of the liquid, reaches a position of the temperature detecting resistance wire 12c, and then reaches a position of the temperature detecting resistance wire 12e. The control substrate 20 detects electrical resistance values of the temperature detecting resistance wire 12c and the temperature detecting resistance wire 12e that change with temperature, to measure temperatures of the temperature detecting resistance wire 12c and the temperature detecting resistance wire 12e.

The control substrate 20 subtracts the temperature of the temperature detecting resistance wire 12c from the temperature of the temperature detecting resistance wire 12b. The temperature detected by the temperature detecting resistance wire 12c upstream of the heating resistance wire 12a in the flow direction FD corresponds to heat that is transferred by the heating resistance wire 12a to the measurement tube 11 and is not transferred to the liquid but is transferred via the measurement tube 11 to the temperature detecting resistance wire 12c. The temperature detecting resistance wire 12b and the temperature detecting resistance wire 12c are arranged at an equal distance to the heating resistance wire 12a.

For that reason, the temperature of the temperature detecting resistance wire 12c is subtracted from the temperature of the temperature detecting resistance wire 12b, so that a temperature of liquid passing the position of the temperature detecting resistance wire 12b can be measured. Similarly, the control substrate 20 can subtract the temperature of the temperature detecting resistance wire 12e from the temperature of the temperature detecting resistance wire 12d, to measure a temperature of liquid passing the position of the temperature detecting resistance wire 12d.

As shown in FIG. 6, in the detection surface 12A, a wiring pattern 12f connected to one end of the heating resistance wire 12a and a wiring pattern 12g connected to the other end of the heating resistance wire 12a are formed. Also, in the detection surface 12A, a wiring pattern 12h connected to one end of the temperature detecting resistance wire 12b, a wiring pattern 12i connected to the other end of the temperature detecting resistance wire 12b and a wiring pattern 12j connected to one end of the temperature detecting resistance wire 12d are formed. The other end of the temperature detecting resistance wire 12d is connected to the wiring pattern 12i.

Also, in the detection surface 12A, a wiring pattern 12k connected to one end of the temperature detecting resistance wire 12c, a wiring pattern 12l connected to the other end of the temperature detecting resistance wire 12c and a wiring pattern 12m connected to one end of the temperature detecting resistance wire 12e are formed. The other end of the temperature detecting resistance wire 12e is connected to the wiring pattern 12l. The wiring patterns 12f, 12g, 12h, 12i, 12j, 12k, 12l, 12m are each formed of a metal film, such as of platinum, evaporated onto the glass substrate.

End portions of the wiring patterns 12f, 12g, 12h, 12i, 12j, 12k, 12l, 12m are joined to metal wiring patterns 60f, 60g, 60h, 60i, 60j, 60k, 60l, 60m arranged in the flexible substrate (the external connection terminal) 60 formed of film resin, respectively. Each of the wiring patterns 60f, 60g, 60h, 60i, 60j, 60k, 60l, 60m of the flexible substrate 60 is electrically connected to the control substrate 20.

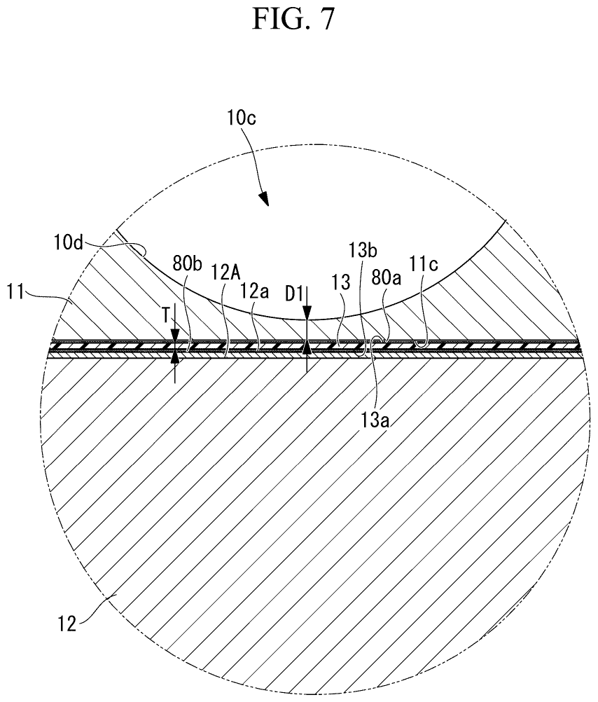

FIG. 7 is a partial enlarged view of the part C of the measurement tube 11 and the sensor substrate 12 illustrated in FIG. 4. As illustrated in FIG. 7, the thermal flow meter 100 of the present embodiment includes a gas permeation blocking sheet 13 made of metal arranged between the flat surface 11c and the detection surface 12A so as to cover the overall region joined to at least the detection surface 12A in the flat surface 11c of the measurement tube 11. The gas permeation blocking sheet 13 has a constant thickness T. For example, the thickness T is set to a range of 0.01 mm or greater and 0.03 mm or less. The gas permeation blocking sheet 13 is formed of a nickel alloy whose main component is nickel (for example, Hastelloy (registered trademark)).

The top face (the first face) 13a of the gas permeation blocking sheet 13 is joined to the flat surface 11c of the measurement tube 11 via a heat welding film 80a. The heat welding film 80a is heated above a predetermined welding temperature, softened, and then cooled and solidified into a state where the top face 13a and the flat surface 11c are joined to each other.

The heat welding film 80a is preferably formed of a fluororesin material such as ethylene tetrafluoroethylene (ETFE), polytetrafluoroethylene (PTFE), polychlorotrifluoroethylene (PCTFE), or tetrafluoroethylene-perfluoroalkyl vinyl ether copolymer (PFA). Forming the heat welding film 80a with a fluororesin material improves the durability of the heat welding film 80a against a corrosive gas that has permeated from the measurement tube 11.

The bottom face (a second face) 13b of the gas permeation blocking sheet 13 is joined to the detection surface 12A of the sensor substrate 12 via the adhesive agent 80b. Note that, in a portion where the temperature detecting resistance wires 12e, 12c, 12b, 12d and the heating resistance wire 12a are formed on the detection surface 12A, the bottom face 13b is joined to these resistance wires.

As the adhesive agent 80b, for example, epoxy resin-based adhesive agents, UV-curable resin-based adhesive agents, thermosetting resin-based adhesive agents, or low-melting-point glass or the like can be used. The adhesive agent 80b is an insulating material having insulating properties and thus has a function of preventing electrical conduction between the metal gas permeation blocking sheet 13 and the heating resistance wire 12a and the temperature detecting resistance wires 12b, 12c, 12d, 12e.

Next, the mixed fluororesin material (the thermal conductive fluororesin material) integrally forming the measurement tube 11 of the present embodiment will be described.

The measurement tube 11 of the present embodiment is formed of a mixed fluororesin material containing a fluororesin material and carbon nanotubes (the thermal conductive material) dispersed in the fluororesin material. Herein, the fluororesin material may be, for example, PTFE, PCTFE, PFA, or the like. As the fluororesin material, powder materials (for example, PTFE G163 manufactured by AGC Inc.) can be used.

Further, as the carbon nanotubes, it is desirable to use those having the following properties, for example:
having a fiber length of 50 μm or greater and 150 μm or less;
having a fiber diameter of 5 nm or greater and 20 nm or less;
having a bulk density of 10 mg/cm³ or greater and 70 mg/cm³ or less;
the G/D ratio being 0.7 or greater and 2.0 or less;
the purity being 99.5% or greater;
being formed of multiple layers (for example, 4 to 12 layers).

Herein, the reason for carbon nanotubes to desirably have a fiber length of 50 μm or greater is to provide sufficient thermal conductivity with a small quantity of carbon nanotubes when the carbon nanotubes are dispersed in the fluororesin material.

Further, the G/D ratio is a value representing a ratio between a peak of the G-band and a peak of the D-band appearing in the Raman spectrum of carbon nanotubes. The G-band is derived from graphite structure, and the D-band is derived from a defect. The G/D ratio represents a ratio of a crystal purity relative to a defect concentration of carbon nanotubes.

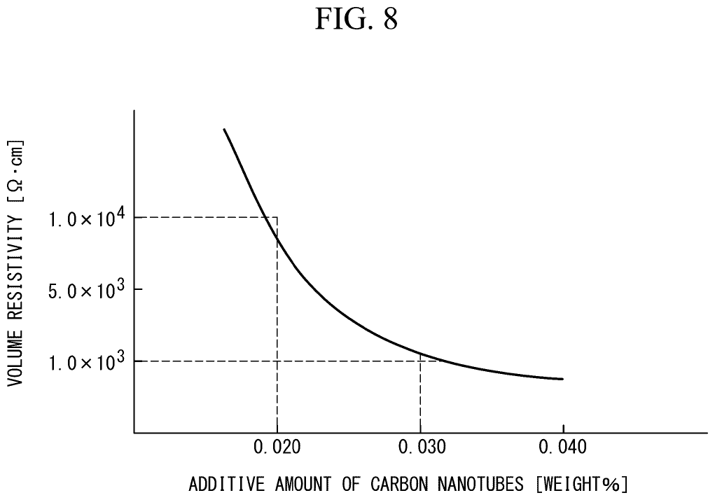

The inventors have examined the relationship between the amount of addition [% by weight] of carbon nanotubes dispersed in the fluororesin material and the volume resistivity [Ω·cm] of the mixed fluororesin material containing the fluororesin material and the carbon nanotubes dispersed therein and then obtained the result illustrated in FIG. 8. The result illustrated in FIG. 8 is a result obtained by measuring the volume resistivity of a test piece based on “Testing method for resistivity of conductive plastics with a four-point probe array” defined by JIS K 7194.

A plurality of test pieces were made by melting and kneading pieces by using a kneader, then compressing and molding the pieces by using a compression molding machine, and machining the pieces into a size conforming to JIS K 7194. The fluororesin material used for making the test pieces was PTFE G163 manufactured by ACG Inc.

Further, a resistivity meter employing four-point probe method conforming to JIS K 7194 was used for measurement of the volume resistivity. The four-point probe method is a method of causing four needle-like probes (electrodes) to be in contact with a test piece and finding the resistance of the test piece based on a value of current conducted between the two outer probes and the potential difference occurring between the two inner probes. The volume resistivity was calculated by averaging measurement values obtained at multiple points from the plurality of test pieces, respectively.

According to the result illustrated in FIG. 8, when the amount of addition of carbon nanotubes is in a range that is greater than or equal to 0.020% by weight and less than or equal to 0.030% by weight, the volume resistivity of the mixed fluororesin material is in a range that is greater than 1.0×10³ Ω⋅cm and less than 1.0×10⁴ Ω·cm. The value of volume resistivity is sufficiently low compared to the value of volume resistivity of the fluororesin material having no carbon nanotubes dispersed therein (10¹⁸ Ω·cm). Further, when the amount of addition of carbon nanotubes is further increased above 0.03% by weight, the volume resistivity is further reduced.

Further, the inventors have obtained the finding that, in the mixed fluororesin material in which carbon nanotubes are added to the fluororesin material containing no carbon nanotubes, there is a negative correlation between the volume resistivity and the thermal conductivity. That is, the inventors have obtained the finding that, when the amount of addition of carbon nanotubes is increased and the volume resistivity is reduced, the thermal conductivity is increased accordingly. Further, the inventors have confirmed that, when the amount of addition of carbon nanotubes in the mixed fluororesin material forming the measurement tube 11 is in a range of 0.020% by weight or greater and 0.060% by weight or less, a liquid flowing through the internal flow channel 10c of the measurement tube 11 can be heated from the heating resistance wire 12a formed on the detection surface 12A of the sensor substrate 12, and the temperature of the heated liquid can be suitably determined by the temperature detecting resistance wires 12b, 12c, 12d, 12e.

Accordingly, in the present embodiment, the amount of addition of carbon nanotubes in the mixed fluororesin material forming the measurement tube 11 is in a range of 0.020% by weight or greater and 0.060% by weight or less. Note that, when PTFE is employed as the fluororesin material, while the thermal conductivity of the measurement tube 11 without addition of carbon nanotubes is 0.53 W/m·k, the thermal conductivity of the measurement tube 11 in which the amount of addition of carbon nanotubes is 0.05% by weight is 0.64 W/m·k.

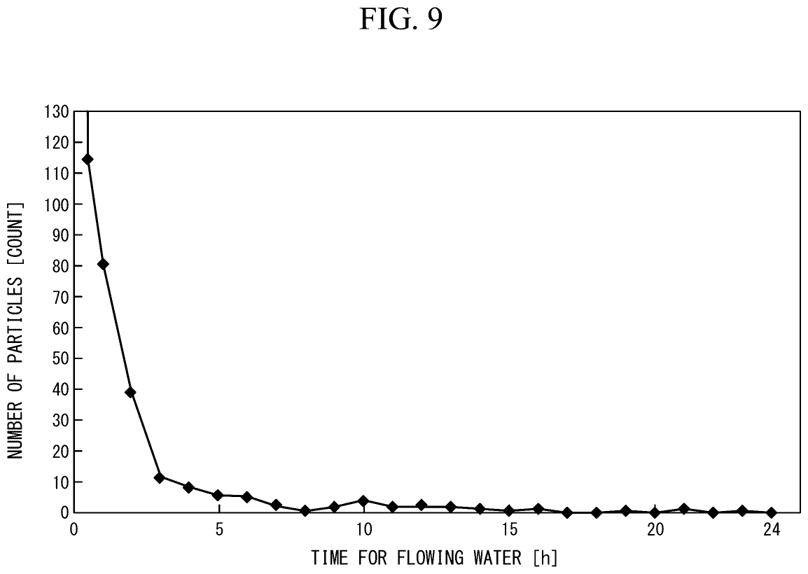

Further, the inventors measured fine particles contained in a liquid flowing through a flow channel formed of the mixed fluororesin material in which the amount of addition of carbon nanotubes is 0.025% by weight. FIG. 9 represents a measurement result illustrating the relationship between the water flow duration in which pure water is allowed to flow and the number of particles measured by a particle counter (not illustrated).

Herein, the number of particles refers to the number of particles having sizes of 0.04 μm or greater contained per 1 ml of pure water. Further, in the measurement illustrated in FIG. 9, the flow rate of pure water allowed to flow through the flow channel was 0.5 litter/min. Further, a blocking state for blocking the flow of pure water and a flow-through state for allowing pure water to flow through were switched therebetween at an interval of 5 seconds. Further, the temperature of the pure water was 25° C.

Although not illustrated in FIG. 9, the number of particles at the start of measurement (when the water flow duration is zero) was about 340. Then, the number of particles gradually decreases with the water flow duration, and after the water flow duration exceeds 4 hours, the number of particles was maintained to 10 or less. Therefore, when the measurement tube 11 is formed of the mixed fluororesin material containing carbon nanotubes at a ratio of 0.020% by weight or greater and 0.060% by weight or less as the amount of addition, and the measurement tube 11 is sufficiently washed with pure water or the like and then made as a product, the number of particles mixed into a liquid from the measurement tube 11 during use can be sufficiently small.

Note that, although FIG. 9 represents the result exhibited by the mixed fluororesin material in which the amount of addition of carbon nanotubes is 0.025% by weight, the inventors have confirmed that, even when the amount of addition of carbon nanotubes is 0.060% by weight, the number of particles does not excessively increase. As discussed above, in the measurement tube 11 of the present embodiment, since the ratio of carbon nanotubes contained in the mixed fluororesin material is a minute ratio of 0.060% by weight or less, contamination of a liquid due to contact with the liquid can be suppressed unlike the case of other granular conductive substances such as carbon black or iron powder.

The effects and advantages achieved by the thermal flow meter 100 of the present embodiment described above will be described.

According to the thermal flow meter 100 of the present embodiment, since the measurement tube 11 in which the internal flow channel 10c is formed that allows a liquid to flow therethrough is formed of a mixed fluororesin material containing a fluororesin material, the corrosion resistance against alkaline or acidic liquids can be enhanced. Further, since the thermal conductive material having higher thermal conductivity than the fluororesin material is dispersed in the mixed fluororesin material forming the measurement tube 11, the thermal conductivity of the measurement tube 11, which contains the fluororesin material having lower thermal conductivity than glass, can be increased. It is thus possible to ensure better thermal conductivity between the measurement tube 11 and a liquid and suitably measure the flow rate of the liquid by using the sensor substrate 12 where the temperature detecting resistance wires 12b, 12c, 12d, 12e are formed on the detection surface 12A while enhancing the corrosion resistance against alkaline or acidic liquids.

According to the thermal flow meter 100 of the present embodiment, because the carbon nanotubes of 0.020% by weight or greater are dispersed in the fluororesin material, the thermal conductivity of the measurement tube 11 can be increased. This is because the use of tubular carbon nanotubes having a predetermined length as the thermal conductive material can add thermal conductivity even with a smaller quantity thereof than in the user of other granular thermal conductive materials such as carbon black or iron powder. Further, since the ratio of the carbon nanotubes contained in the thermal conductive fluororesin material is a minute ratio of 0.060% by weight or less, contamination of a liquid due to contact between the measurement tube 11 and the liquid can be suppressed unlike the case of other granular thermal conductive materials such as carbon black or iron powder.

According to the thermal flow meter 100 of the present embodiment, because the flat surface 11c formed on the outer circumferential surface of the measurement tube 11 and the detection surface 12A formed flat are joined to each other, a wide contact area can be ensured to enhance joinability therebetween.

According to the thermal flow meter 100 of the present embodiment, since a metal gas permeation blocking sheet 13 is arranged between the flat surface 11c of the measurement tube 11 and the detection surface 12A of the sensor substrate 12 so as to cover the flat surface 11c, even when a part of a corrosive gas volatilized from a liquid flowing inside the measurement tube 11 permeates the measurement tube 11, it is possible to suitably prevent the corrosive gas from corroding the heating resistance wire 12a and the temperature detecting resistance wires 12b, 12c, 12d, 12e.

According to the thermal flow meter 100 of the present embodiment, by using the heat welding film 80a to perform joining between the top face 13a of the gas permeation blocking sheet 13, which is susceptible to a corrosive gas permeating the measurement tube 11, and the flat surface 11c of the measurement tube 11, it is possible to suitably perform the joining while preventing the impact of a corrosive gas. Further, it is possible to suitably join the bottom face 13b of the gas permeation blocking sheet 13 and the detection surface 12A of the sensor substrate 12 by using the adhesive agent 80b.

According to the thermal flow meter 100 of the present embodiment, the use of the gas permeation blocking sheet 13 formed of a nickel alloy containing nickel as the main component can reliably prevent a corrosive gas from corroding the heating resistance wire 12a and the temperature detecting resistance wires 12b, 12c, 12d, 12e. According to the thermal flow meter 100 of the present embodiment, since the distance D1 from the detection surface 12A of the sensor substrate 12 to the inner circumferential surface 10d of the internal flow channel 10c is shorter than the distance D2 from the top 11d of the measurement tube 11 to the inner circumferential surface 10d of the internal flow channel 10c, the heating property on a liquid inside the internal flow channel 10c applied by the heating resistance wire 12a and the temperature detection property on a liquid applied by the temperature detecting resistance wires 12b, 12c, 12d, 12e can be enhanced compared to a case where the first and second distances are the same.

According to the thermal flow meter 100 of the present embodiment, since the glass sensor substrate 12 less likely to be deformed by heating is used, bending that may occur during adhesion of the sensor substrate 12 to the measurement tube 11 or during the use thereof can be suppressed.

### Other Embodiments

Although the thermal flow meter 100 includes the gas permeation blocking sheet 13 made of metal arranged between the flat surface 11c and the detection surface 12A so as to cover the overall region joined to at least the detection surface 12A in the flat surface 11c of the measurement tube 11 in the above description, other forms may be employed. For example, when a liquid flowing through the internal flow channel 10c of the measurement tube 11 does not generate a corrosive gas or generates only an extremely small amount of a corrosive gas that permeates the measurement tube 11 to outside, no gas permeation blocking sheet 13 may be provided.

In such a case, the flat surface 11c of the measurement tube 11 and the detection surface 12A of the sensor substrate 12 are joined to each other via the heat welding film 80a or the adhesive agent 80b. Since there is no gas permeation blocking sheet 13 between the flat surface 11c and the detection surface 12A, the thermal conductivity between the flat surface 11c and the detection surface 12A is improved. When the heat welding film 80a formed of the fluororesin material is used, a reduction in joining force between the flat surface 11c and the detection surface 12A can be suppressed even when there is permeation of a corrosive gas from the measurement tube 11.

What is claimed is:

1. A thermal flow meter comprising:
a measurement tube having an inflow port and an outflow port and having an internal flow channel formed extending along an axis, wherein a liquid flows into the inflow port and the liquid flowing in from the inflow port is allowed to flow out of the outflow port; and
a temperature detecting substrate having a heating resistance element and a temperature detecting resistance element formed on a detection surface along the axis, the detection surface being joined to the measurement tube along the axis,
wherein the measurement tube is formed of a thermal conductive fluororesin material containing a fluororesin material and a thermal conductive material, the thermal conductive material being dispersed in the fluororesin material and having higher thermal conductivity than the fluororesin material.

2. The thermal flow meter according to claim 1,
wherein the thermal conductive material consists of carbon nanotubes, and
wherein the thermal conductive fluororesin material contains the carbon nanotubes at a ratio of 0.020% by weight or greater and 0.060% by weight or less.

3. The thermal flow meter according to claim 1,
wherein the detection surface is a surface formed flat, and
wherein a flat surface joined to the detection surface of the temperature detecting substrate is formed on an outer circumferential surface of the measurement tube.

4. The thermal flow meter according to claim 3 further comprising a metal sheet arranged between the flat surface of the measurement tube and the detection surface of the temperature detecting substrate so as to cover the flat surface,
wherein a first face of the sheet is joined to the flat surface of the measurement tube, and
wherein a second face of the sheet is joined to the detection surface of the temperature detecting substrate.

5. The thermal flow meter according to claim 4,
wherein the first face of the sheet and the flat surface of the measurement tube are joined to each other via a heat welding film, and
wherein the second face of the sheet and the detection surface of the temperature detecting substrate are joined to each other via an adhesive agent.

6. The thermal flow meter according to claim 4, wherein the sheet is formed of a nickel alloy containing nickel as a main component.

7. The thermal flow meter according to claim 1, wherein a first distance from the detection surface of the temperature detecting substrate to an inner circumferential surface of the internal flow channel is shorter than a second distance from the top of the measurement tube to the inner circumferential surface of the internal flow channel.

8. The thermal flow meter according to claim 1, wherein the temperature detecting substrate is made of glass.
